(19) United States
(12) Patent Application Publication
(10) Pub. No.: US 2018/0267807 A1
(43) Pub. Date: Sep. 20, 2018

(54) PRECISE EXCEPTIONS FOR EDGE PROCESSORS

(71) Applicant: Microsoft Technology Licensing, LLC, Redmond, WA (US)

(72) Inventors: Douglas C. Burger, Bellevue, WA (US); Gagan Gupta, Bellevue, WA (US)

(73) Assignee: Microsoft Technology Licensing, LLC, Redmond, WA (US)

(21) Appl. No.: 15/595,582

(22) Filed: May 15, 2017

Related U.S. Application Data
(60) Provisional application No. 62/471,890, filed on Mar. 15, 2017.

(51) Int. Cl. G06F 9/38; G06F 9/48; G06F 15/78

(52) U.S. Cl. CPC G06F 9/3861; G06F 15/7839; G06F 9/4812; G06F 9/4806

(57) ABSTRACT

Systems and methods are disclosed for supporting debugging of programs in block-based processor architectures. In one example of the disclosed technology, a processor includes an exception event handler, a memory interface, at least one block-based processor core coupled to the memory interface and configured to responsive to receiving an exception event signal while executing an instruction block, store state data for the core generated by executing the instruction block, transfer control of the core to a second instruction block, and resume execution of the first instruction by restoring state for the processor core from the stored state data.

### CROSS-REFERENCE TO RELATED APPLICATIONS

This application claims the benefit of U.S. Provisional Application No. 62/471,890, filed Mar. 15, 2017, which application is incorporated herein by reference in its entirety.

### BACKGROUND

Microprocessors have benefited from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Apparatus and methods are disclosed for handling exception events such as software exceptions and hardware interrupts in block-based and Explicit Data Graph Execution (EDGE) processor architectures. As such processors can use relatively large atomic blocks of instructions, the disclosed technology can be used to handle such exceptions, avoiding undo delay, while providing a suitable debugging environment for restoring processor state after handling such exceptions. In some examples, the event exceptions may be handled by resuming the interrupted instruction block at the point where the event interrupted execution of the block, by resuming execution at the start of the block, or by processing the event after the block commits Thus, issues with instruction side effects may be avoided by, for example, preventing redundant memory accesses that can cause unwanted, additional side effects.

In some examples of the disclosed technology, a block-based processor is configured to perform a method of handling unexpected events. The method includes executing a portion of instructions of a first instruction block and logging results generated by the executing portion in a memory. For example, the memory can be a load store queue, shadow registers, or context data stored on a processor stack. An exception event is received and processed by transferring control of the processor to a second instruction block. A second instruction block can process the event by, for example, invoking a debugger, or executing functions provided by the operating system. After the exception event is processed, the first instruction block can be resumed by restoring the processor state using the logged results stored in the memory, and executing the next portion of the first instruction block that does not include executed instructions for which results were logged. In some examples, the resuming execution includes re-executing one or more of the instructions, at least some of the instructions being re-executed using stored result date from the logged results, to avoid side effects.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Any trademarks used herein remain the property of their respective owners. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, as can be used in certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 is a block diagram outlining example hardware for resuming execution of an instruction block after processing an exception event, as can be used in certain examples of the disclosed technology.

FIG. 8 is a diagram illustrating execution flow in one example of handling exception events in a block-based processor, as can be implemented in certain examples of the disclosed technology.

FIGS. 9A and 9B are diagrams illustrating another example of processing an exception event, as can be used in certain examples of the disclosed technology.

FIG. 10 is a diagram illustrating another way of processing exception events in a block-based processor, as can be performed in certain examples of the disclosed technology.

FIG. 11 is a flowchart outlining an example method of restoring processor state after receiving an exception event, as can be performed in certain examples of the disclosed technology.

FIG. 12 is a flowchart outlining an example method of restoring instruction block state after receiving an exception event signal, as can be performed in certain examples of the disclosed technology.

FIG. 13 is a flowchart outlining an example method of transferring control to an event handler for processing a received exception event signal, as can be performed in certain examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (including random-access memory, such as dynamic RAM (DRAM), static RAM (SRAM), or embedded DRAM (eDRAM), or non-random access memories, such as certain configurations of registers, buffers, or queues), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block-based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented with software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an EDGE ISA includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Intermediate results produced by the instructions within an atomic instruction block are buffered locally until the instruction block is committed. When the instruction block is committed, updates to the visible architectural state resulting from executing the instructions of the instruction block are made visible to other instruction blocks. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

As will be readily understood to one of ordinary skill in the relevant art, a spectrum of implementations of the disclosed technology are possible with various area, performance, and power tradeoffs.

### III. Example Block-Based Processor

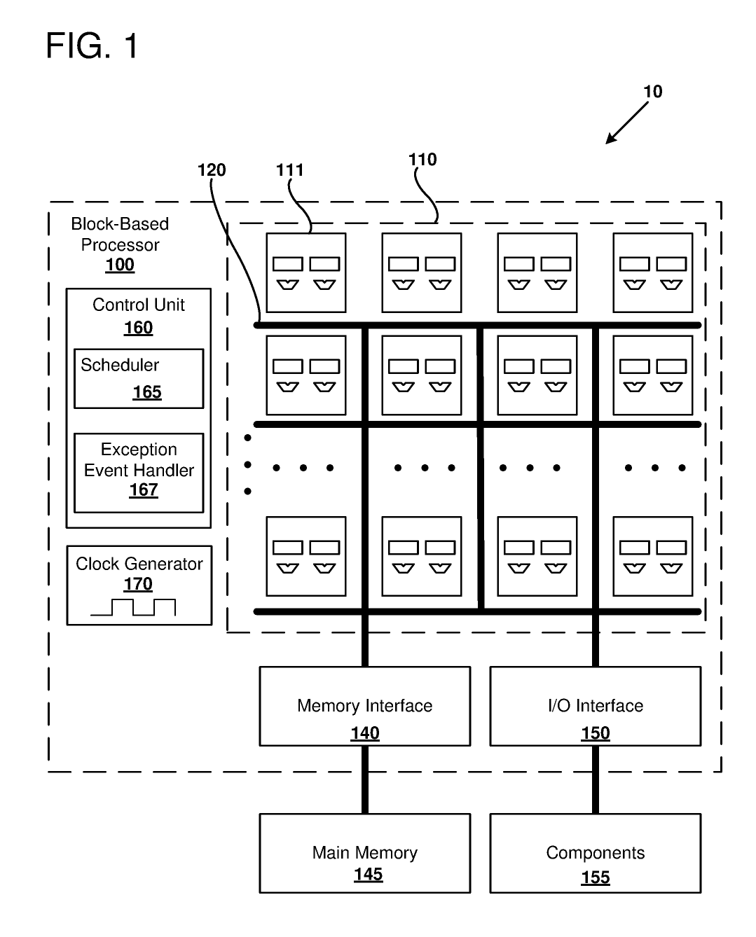

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, exception models, and other architectural features. The block-based processor includes a plurality of one or more processing cores 110, including a processor core 111. The block-based processor can be implemented in as a custom or application-specific integrated circuit (e.g., including a system-on-chip (SoC) integrated circuit), as a field programmable gate array (FPGA) or other reconfigurable logic, or as a soft processor virtual machine hosted by a physical general purpose processor.

As shown in FIG. 1, the processor cores are connected to each other via core interconnect 120. The core interconnect 120 carries data and control signals between individual ones of the cores 110, a memory interface 140, and an input/output (I/O) interface 150. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to memory 145, for example, memory located on another integrated circuit besides the processor 100 (e.g., the memory can be static RAM (SRAM) or dynamic RAM (DRAM)), or memory embedded on the same integrated circuit as the processor (e.g., embedded SRAM or DRAM (eDRAM)). The memory interface 140 and/or the main memory can include caches (e.g., n-way or associative caches) to improve memory access performance In some examples the cache is implemented using static RAM (SRAM) and the main memory 145 is implemented using dynamic RAM (DRAM). In some examples the memory interface 140 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 manages allocation of virtual memory, expanding the available main memory 145. In some examples, support for bypassing cache structures or for ensuring cache coherency when performing memory synchronization operations (e.g., handling contention issues or shared memory between plural different threads, processes, or processors) are provided by the memory interface 140 and/or respective cache structures. The memory interface 140 can also include a translation lookaside buffer (TLB), which caches mappings of virtual memory addresses to physical memory addresses. The TLB can raise a signal when a requested virtual memory address is not currently cached in the TLB, thereby raising an exception.

The I/O interface 150 includes circuitry for receiving and sending input and output signals to other components 155, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140. In some examples the I/O signal implementation is not limited to full swing electrical digital signals, but the I/O interface 150 can be configured to provide differential signals, pulsed signals, or other suitable signals for transmitting data and control signals.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 150, modification of execution flow, and verifying target location(s) of branch instructions, instruction headers, and other changes in control flow. The control unit 160 can generate and control the processor according to control flow and metadata information representing exit points and control flow probabilities for instruction blocks. The control unit can be used to control data flow between general-purpose portions of the processor cores 110.

The control unit 160 can also process hardware interrupts, and control reading and writing of special system registers, for example a program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory, a hard macro processor block provided in an FPGA, or a general purpose soft processor). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler 165 used to control instruction pipelines of the processor cores 110. In other examples, schedulers can be arranged so that they are contained with each individual processor core. As used herein, scheduler block allocation refers to directing operation of an instruction blocks, including initiating instruction block mapping, fetching, decoding, execution, committing, aborting, idling, and refreshing an instruction block. Further, instruction scheduling refers to scheduling the issuance and execution of instructions within an instruction block. For example, based on instruction dependencies and data indicating a relative ordering for memory access instructions, the control unit 160 can determine which instruction(s) in an instruction block are ready to issue and initiate issuance and execution of the instructions. Processor cores 110 are assigned to instruction blocks during instruction block mapping. The recited stages of instruction operation are for illustrative purposes and in some examples of the disclosed technology, certain operations can be combined, omitted, separated into multiple operations, or additional operations added. The scheduler 165 schedules the flow of instructions, including allocation and de-allocation of cores for performing instruction processing, control of input data and output data between any of the cores, register files, the memory interface 140, and/or the I/O interface 150.

An exception event handler 167 controls processing of exception events such as software exceptions and hardware interrupts. In particular, the exception event handler 167 can be used to receive exception events, intercede in execution of an instruction block, including transferring control to an event handler, and control resuming operation by the interrupted instruction block. State data for the interrupted instruction block can be logged, and this stored data used to restore at least a portion of instruction window state when the block resumes. In some examples, the instruction block resumes at the interrupted instruction, in other examples, the block is rewound to a starting instruction and the same portion of instructions is re-executed. In some examples, processing of the exception is delayed until the instruction block commits

The block-based processor 100 also includes a clock generator 170, which distributes one or more clock signals to various components within the processor (e.g., the cores 110, interconnect 120, memory interface 140, and I/O interface 150). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

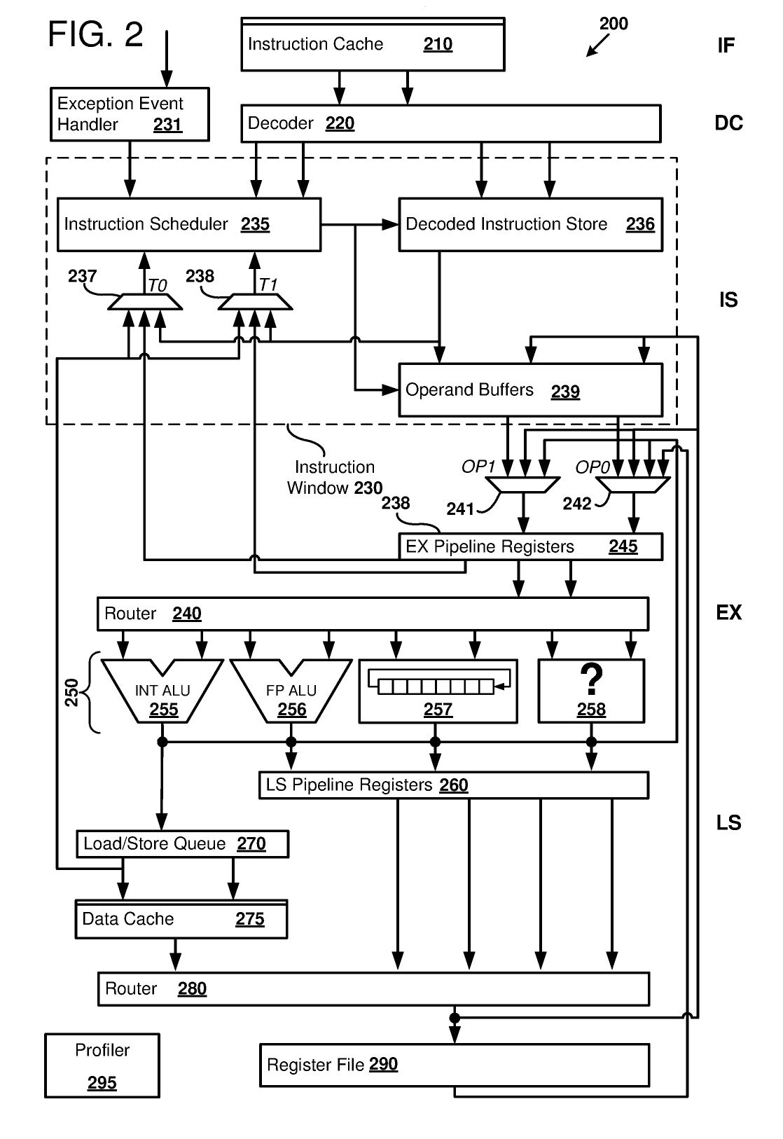

FIG. 2 is a block diagram further detailing an example microarchitecture 200 for implementing the block-based processor 100, and in particular, an instance of one of the block-based processor cores, as can be used in certain examples of the disclosed technology. For ease of explanation, the exemplary microarchitecture has five pipeline stages including: instruction fetch (IF), decode (DC), issue, including operand fetch (IS), execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core includes an instruction cache 210 that is coupled to an instruction decoder 220. The instruction cache 210 is configured to receive block-based processor instructions from a memory. In some FPGA implementations, the instruction cache can be implemented by a dual read port, dual write port, 18 or 36 Kb (kilobit), 32-bit wide block RAM. In some examples, the physical block RAM is configured to operate as two or more smaller block RAMs.

The processor core further includes an instruction window 230, which includes an instruction scheduler 235, a decoded instruction store 236, and a plurality of operand buffers 239. In FPGA implementations, each of these instruction window components 230 can be implemented including the use of LUT RAM (e.g., with SRAM configured as lookup tables) or BRAM (block RAM). The instruction scheduler 235 can send an instruction identifier (instruction ID or IID) for an instruction to the decoded instruction store 236 and the operand buffers 239 as a control signal. As discussed further below, each instruction in an instruction block has an associated instruction identifier that uniquely identifies the instruction within the instruction block. In some examples, instruction targets for sending the result of executing an instruction are encoded in the instruction. In this way, dependencies between instructions can be tracked using the instruction identifier instead of monitoring register dependencies. In some examples, the processor core can include two or more instruction windows. In some examples, the processor core can include one instruction window with multiple block contexts.

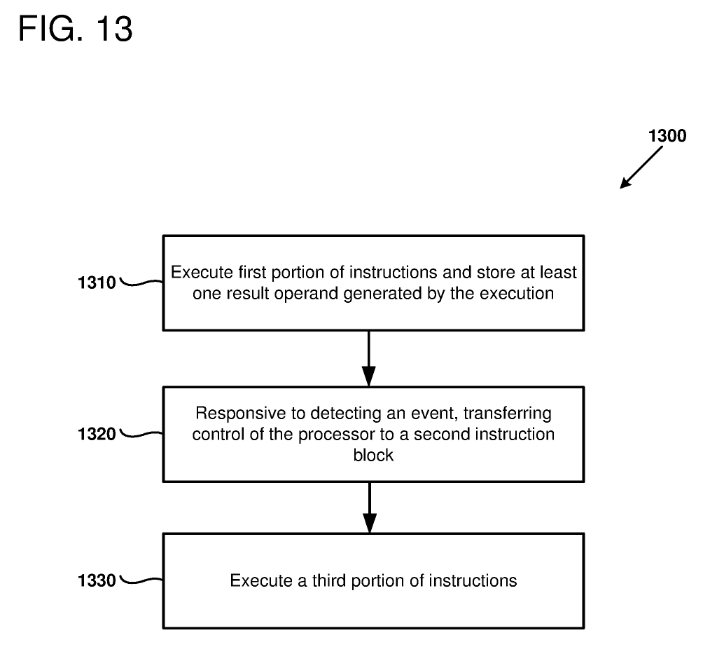

An exception event handler 231 controls processing of exception events such as software exceptions and hardware interrupts. In particular, the exception event handler 231 can be used to receive exception events, intercede in execution of an instruction block, including transferring control to an event handler (e.g., implemented as a number of other instruction blocks forming part of an operating system), and control resuming operation by returning control to the interrupted instruction block. In some examples, the exception event handler 231 is configured to transfer control to an event handler, and return control to a third, different instruction block. For example, try/catch blocks can define instruction blocks where control is resumed at a third, different instruction block, as discussed further below in the example method of FIG. 13. State data for the interrupted instruction block can be logged, and this stored data used to restore at least a portion of instruction window state when the block resumes. In some examples, the instruction block resumes at the interrupted instruction, in other examples, the block is rewound to a starting instruction and the same portion of instructions is re-executed. In some examples, processing of the exception is delayed until the instruction block commits. As shown in FIG. 2, the example microarchitecture 200 has an exception event handler for each processor core. In other examples, a processor includes an exception event handler that is used by two or more processor cores (e.g., as shown with the exception event handler 167 of FIG. 1).

As will be discussed further below, the microarchitecture 200 includes a register file 290 that stores data for registers defined in the block-based processor architecture, and can have one or more read ports and one or more write ports. Because an instruction block executes on a transactional basis, changes to register values made by an instance of an instruction block are not visible to the same instance; the register writes will be committed upon completing execution of the instruction block.

The example microarchitecture 200 also includes a hardware profiler 295. The hardware profiler 295 can collect information about programs that execute on the processor. For examples, data regarding events, function calls, memory locations, and other information can be collected (e.g., using hardware instrumentation such as registers, counters, and other circuits) and analyzed to determine which portions of a program might be optimized.

The decoded instruction store 236 stores decoded signals for controlling operation of hardware components in the processor pipeline. For example, a 32-bit instruction may be decoded into 128-bits of decoded instruction data. The decoded instruction data is generated by the decoder 220 after an instruction is fetched. The operand buffers 239 store operands (e.g., register values received from the register file, data received from memory, immediate operands coded within an instruction, operands calculated by an earlier-issued instruction, or other operand values) until their respective decoded instructions are ready to execute. Instruction operands and predicates for the execute phase of the pipeline are read from the operand buffers 239, respectively, not (directly, at least) from the register file 290. The instruction window 230 can include a buffer for predicates directed to an instruction, including wired-OR logic for combining predicates sent to an instruction by multiple instructions.

In some examples, all of the instruction operands, except for register read operations, are read from the operand buffers 239 instead of the register file. In some examples the values are maintained until the instruction issues and the operand is communicated to the execution pipeline. In some FPGA examples, the decoded instruction store 236 and operand buffers 239 are implemented with a plurality of LUT RAMs.

The instruction scheduler 235 maintains a record of ready state of each decoded instruction's dependencies (e.g., the instruction's predicate and data operands). When all of the instruction's dependencies (if any) are satisfied, the instruction wakes up and is ready to issue. In some examples, the lowest numbered ready instruction ID is selected each pipeline clock cycle and its decoded instruction data and input operands are read. Besides the data mux and function unit control signals, the decoded instruction data can encode up to two ready events in the illustrated example. The instruction scheduler 235 accepts these and/or events from other sources (selected for input to the scheduler on inputs T0 and T1 with multiplexers 237 and 238, respectively) and updates the ready state of other instructions in the window. Thus dataflow execution proceeds, starting with the instruction block's ready zero-input instructions, then instructions that these instructions target, and so forth. Some instructions are ready to issue immediately (e.g., move immediate instructions) as they have no dependencies. Depending on the ISA, control structures, and other factors, the decoded instruction store 236 is about 100 bits wide in some examples, and includes information on instruction dependencies, including data indicating which target instruction(s)'s active ready state will be set as a result of issuing the instruction.

As used herein, ready state refers to processor state that indicates, for a given instruction, whether and which of its operands (if any) are ready, and whether the instruction itself is now ready for issue. In some examples, ready state includes decoded ready state and active ready state. Decoded ready state data is initialized by decoding instruction(s). Active ready state represents the set of input operands of an instruction that have been evaluated so far during the execution of the current instance of an instruction block. A respective instruction's active ready state is set by executing instruction(s) which target, for example, the left, right, and/or predicate operands of the respective instruction.

Attributes of the instruction window 230 and instruction scheduler 235, such as area, clock period, and capabilities can have significant impact to the realized performance of an EDGE core and the throughput of an EDGE multiprocessor. In some examples, the front end (IF, DC) portions of the microarchitecture can run decoupled from the back end portions of the microarchitecture (IS, EX, LS). In some FPGA implementations, the instruction window 230 is configured to fetch and decode two instructions per clock into the instruction window.

The instruction scheduler 235 has diverse functionality and requirements. It can be highly concurrent. Each clock cycle, the instruction decoder 220 writes decoded ready state and decoded instruction data for one or more instructions into the instruction window 230. Each clock cycle, the instruction scheduler 235 selects the next instruction(s) to issue, and in response the back end sends ready events, for example, target ready events targeting a specific instruction's input slot (e.g., predicate slot, right operand (OP0), or left operand (OP1)), or broadcast ready events targeting all instructions waiting on a broadcast ID. These events cause per-instruction active ready state bits to be set that, together with the decoded ready state, can be used to signal that the corresponding instruction is ready to issue. The instruction scheduler 235 sometimes accepts events for target instructions which have not yet been decoded, and the scheduler can also inhibit reissue of issued ready instructions.

Control circuits (e.g., signals generated using the decoded instruction store 236) in the instruction window 230 are used to generate control signals to regulate core operation (including, e.g., control of datapath and multiplexer select signals) and to schedule the flow of instructions within the core. This can include generating and using memory access instruction encodings, allocation and de-allocation of cores for performing instruction processing, control of input data and output data between any of the cores 110, register files, the memory interface 140, and/or the I/O interface 150.

In some examples, the instruction scheduler 235 is implemented as a finite state machine coupled to the other instruction window logic. In some examples, the instruction scheduler is mapped to one or more banks of RAM in an FPGA, and can be implemented with block RAM, LUT RAM, or other reconfigurable RAM. As will be readily apparent to one of ordinary skill in the relevant art, other circuit structures, implemented in an integrated circuit, programmable logic, or other suitable logic can be used to implement hardware for the instruction scheduler 235. In some examples of the disclosed technology, front-end pipeline stages IF and DC can run decoupled from the back-end pipelines stages (IS, EX, LS).

In the example of FIG. 2, the operand buffers 239 send the data operands, which can be designated left operand (LOP) and right operand (ROP) for convenience, to a set of execution state pipeline registers 245 via one or more switches (e.g., multiplexers 241 and 242). These operands can also be referred to as OP1 and OP0, respectively. A first router 240 is used to send data from the operand buffers 239 to one or more of the functional units 250, which can include but are not limited to, integer ALUs (arithmetic logic units) (e.g., integer ALUs 255), floating point units (e.g., floating point ALU 256), shift/rotate logic (e.g., barrel shifter 257), or other suitable execution units, which can including graphics functions, physics functions, and other mathematical operations. In some examples, a programmable execution unit 258 can be reconfigured to implement a number of different arbitrary functions (e.g., a priori or at runtime).

Data from the functional units 250 can then be routed through a second router (not shown) to a set of load/store pipeline registers 260, to a load/store queue 270 (e.g., for performing memory load and memory store operations), or fed back to the execution pipeline registers, thereby bypassing the operand buffers 239. The load/store queue 270 is coupled to a data cache 275 that caches data for memory operations. The outputs of the data cache 275, and the load/store pipelines registers 260 can be sent to a third router 280, which in turn sends data to the register file 290, the operand buffers 239, and/or the execution pipeline registers 245, according to the instruction being executed in the pipeline stage.

When execution of an instruction block is complete, the instruction block is designated as “committed” and signals from the control outputs can in turn can be used by other cores within the block-based processor 100 and/or by the control unit 160 to initiate scheduling, fetching, and execution of other instruction blocks.

As will be readily understood to one of ordinary skill in the relevant art, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window and control unit of the processor cores 110. The area, clock period, capabilities, and limitations substantially determine the realized performance of the individual cores 110 and the throughput of the block-based processor 100.

Updates to the visible architectural state of the processor (such as to the register file 290 and the memory) affected by the executed instructions can be buffered locally within the core until the instructions are committed. The control circuitry can determine when instructions are ready to be committed, sequence the commit logic, and issue a commit signal. For example, a commit phase for an instruction block can begin when all register writes are buffered, all writes to memory (including unconditional and conditional stores) are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control circuit also controls, at least in part, allocation of functional units to the instructions window.

Because the instruction block is committed (or aborted) as an atomic transactional unit, it should be noted that results of certain operations are not available to instructions within an instruction block. This is in contrast to RISC and CISC architectures that provide results visible on an individual, instruction-by-instruction basis. Thus, additional techniques are disclosed for supporting memory synchronization and other memory operations in a block-based processor environment.

In some examples, block-based instructions can be non-predicated, or predicated true or false. A predicated instruction does not become ready until it is targeted by another instruction's predicate result, and that result matches the predicate condition. If the instruction's predicate does not match, then the instruction never issues.

In some examples, upon branching to a new instruction block, all instruction window ready state (stored in the instruction scheduler 235) is flash cleared (block reset). However when a block branches back to itself (block refresh), only active ready state is cleared; the decoded ready state is preserved so that it is not necessary to re-fetch and decode the blocks instructions. Thus, refresh can be used to save time and energy in loops, instead of performing a block reset.

Since some software critical paths include a single chain of dependent instructions (for example, instruction A targets instruction B, which in turn targets instruction C), it is often desirable that the dataflow scheduler not add pipeline bubbles for successive back-to-back instruction wakeup. In such cases, the IS-stage ready-issue-target-ready pipeline recurrence should complete in one cycle, assuming that this does not severely affect clock frequency.

Instructions such as ADD have a latency of one cycle. With EX-stage result forwarding, the scheduler can wake their targets' instructions in the IS-stage, even before the instruction completes. Other instruction results may await ALU comparisons, take multiple cycles, or have unknown latency. These instructions wait until later to wake their targets.

Finally, the scheduler design can be scalable across a spectrum of EDGE ISAs. In some examples, each pipeline cycle can accept from one to four decoded instructions and from two to four target ready events, and issue one to two instructions per cycle.

A number of different technologies can be used to implement the exception event handler 231 and the instruction scheduler 235. For example, the scheduler 235 can be implemented as a parallel scheduler, where instructions' ready state is explicitly represented in D-type flip-flops (FFs), and in which the ready status of every instruction is reevaluated each cycle. In other examples, the instruction scheduler 235 can be implemented as a more compact incremental scheduler that keeps ready state in LUT RAM and which updates ready status of about two to four target instructions per cycle.

The register file 290 may include two or more write ports for storing data in the register file, as well as having a plurality of read ports for reading data from individual registers within the register file. In some examples, a single instruction window (e.g., instruction window 230) can access only one port of the register file at a time, while in other examples, the instruction window 230 can access one read port and one write port, or can access two or more read ports and/or write ports simultaneously. In some examples, the microarchitecture is configured such that not all the read ports of the register file 290 can use the bypass mechanism. For the example microarchitecture 200 shown in FIG. 2, the register file can send register data on the bypass path to one of the multiplexers 242 for the operand OP0, but not operand OP1. Thus, for multiple register reads in one cycle, only one operand can use the bypass, while the other register read results are sent to the operand buffers 239, which inserts an extra clock cycle in the instruction pipeline.

In some examples, the register file 290 can include 64 registers, each of the registers holding a word of 32 bits of data. (For convenient explanation, this application will refer to 32-bits of data as a word, unless otherwise specified. Suitable processors according to the disclosed technology could operate with 8-, 16-, 64-, 128-, 256-bit, or another number of bits words) In some examples, some of the registers within the register file 290 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, execution flags, a processor topology, or other suitable dedicated purpose. In some examples, the register file 290 is implemented as an array of flip-flops, while in other examples, the register file can be implemented using latches, SRAM, FPGA LUT RAM, FPGA block RAM, or other forms of memory storage. The ISA specification for a given processor specifies how registers within the register file 290 are defined and used.

### V. Example Stream of Instruction Blocks

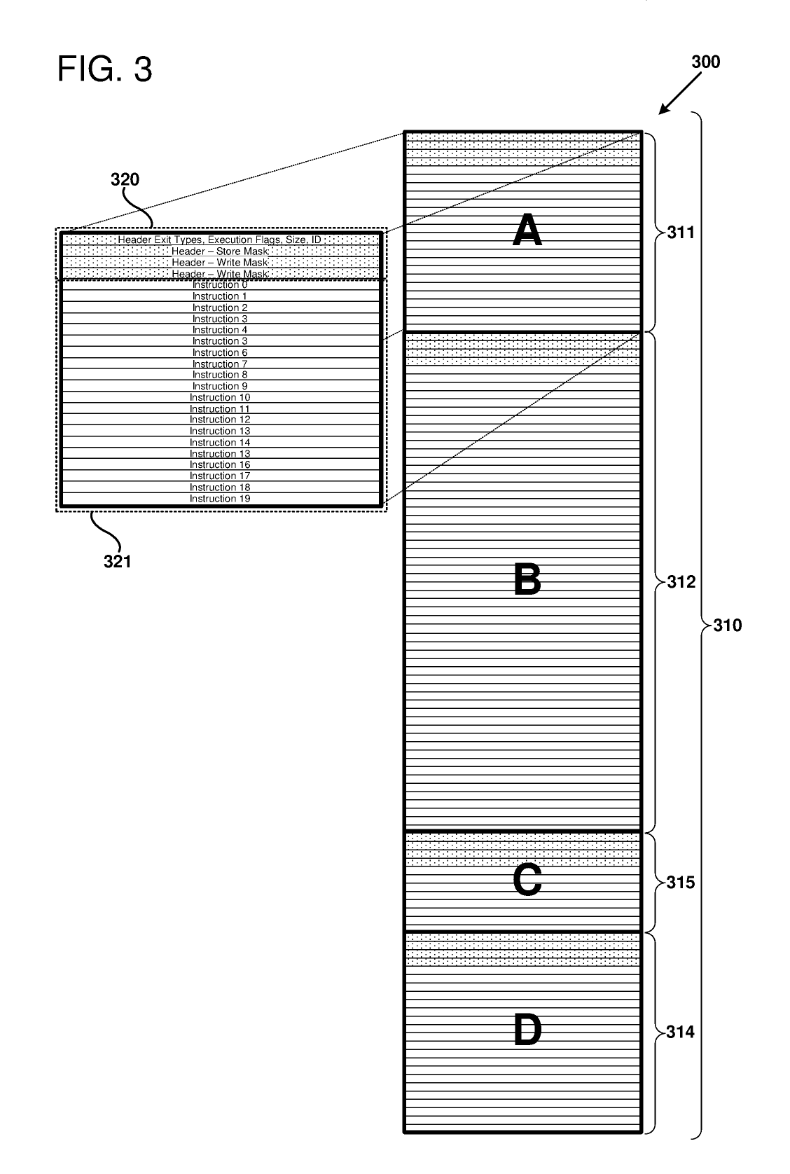

Turning now to the diagram 300 of FIG. 3, a portion 310 of a stream of block-based instructions, including a number of variable length instruction blocks 311-314 is illustrated. The stream of instructions can be used to implement user application, system services, or any other suitable use. The stream of instructions can be stored in memory, received from another process in memory, received over a network connection, or stored or received in any other suitable manner In the example shown in FIG. 3, each instruction block begins with an instruction header, which is followed by a varying number of instructions. For example, the instruction block 311 includes a header 320 and twenty instructions 321. The particular instruction block header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of zero (0) indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include one or more execution flags that indicate one or more modes of operation for executing the instruction block. For example, the modes of operation can include core fusion operation, vector mode operation, memory dependence prediction, and/or in-order or deterministic instruction execution. Further, the execution flags can include a block synchronization flag that inhibits speculative execution of the instruction block.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, exception processing, branch prediction, control flow determination, and/or branch processing. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The illustrated instruction block header 320 also includes a store mask that indicates which of the load-store queue identifiers encoded in the block instructions are assigned to store operations. The instruction block header can also include a write mask, which identifies which global register(s) the associated instruction block will write. In some examples, the store mask is stored in a store vector register by, for example, an instruction decoder (e.g., decoder 220). In other examples, the instruction block header 320 does not include the store mask, but the store mask is generated dynamically by the instruction decoder by analyzing instruction dependencies when the instruction block is decoded. For example, the decoder can generate load store identifiers for instruction block instructions to determine a store mask and store the store mask data in a store vector register. Similarly, in other examples, the write mask is not encoded in the instruction block header, but is generated dynamically (e.g., by analyzing registers referenced by instructions in the instruction block) by an instruction decoder) and stored in a write mask register. The write mask can be used to determine when execution of an instruction block has completed and thus to initiate commitment of the instruction block. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

Examples of suitable block-based instructions that can be used for the instructions 321 can include instructions for executing integer and floating-point arithmetic, logical operations, type conversions, register reads and writes, memory loads and stores, execution of branches and jumps, and other suitable processor instructions. In some examples, the instructions include instructions for configuring the processor to operate according to one or more of operations by, for example, speculative. Because an instruction's dependencies are encoded in the instruction block (e.g., in the instruction block header, other instructions that target the instruction, and/or in the instruction itself), instructions can issue and execute out of program order when the instruction's dependencies are satisfied.

### VI. Example Block Instruction Target Encoding

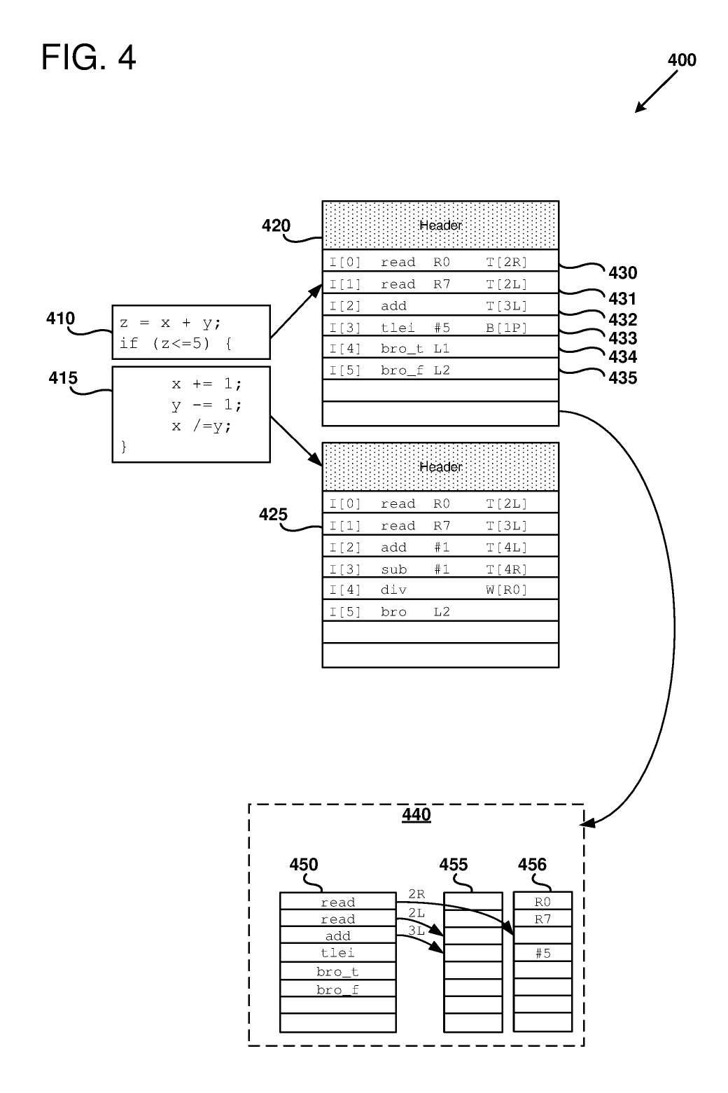

FIG. 4 is a diagram 400 depicting an example of two portions 410 and 415 of C language source code and their respective instruction blocks 420 and 425, illustrating how block-based instructions can explicitly encode their targets. In this example, the first two READ instructions 430 and 431 target the right (T[2R]) and left (T[2L]) operands, respectively, of the ADD instruction 432 (2R indicates targeting the right operand of instruction number 2; 2L indicates the left operand of instruction number 2). In the illustrated ISA, the read instruction is the only instruction that reads from the global register file (e.g., register file 290); however any instruction can target the global register file. When the ADD instruction 432 receives the results of both register reads it will become ready and execute. It is noted that the present disclosure sometimes refers to the right operand as OP0 and the left operand as OP1.

When the TLEI (test-less-than-equal-immediate) instruction 433 receives its single input operand from the ADD, it will become ready to issue and execute. The test then produces a predicate operand that is broadcast on channel one (B[1P]) to all instructions listening on the broadcast channel for the predicate, which in this example are the two predicated branch instructions (BRO_T 434 and BRO_F 435). The branch instruction that receives a matching predicate will issue, but the other instruction, encoded with the complementary predicated, will not issue.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers RO and R7 are written into the right and left operand buffers of ADD 432, marking the left and right operands of ADD 432 “ready.” As a result, the ADD 432 instruction becomes ready, issues to an ALU, executes, and the sum is written to the left operand of the TLEI instruction 433.

### VII. Example Block-Based Instruction Formats

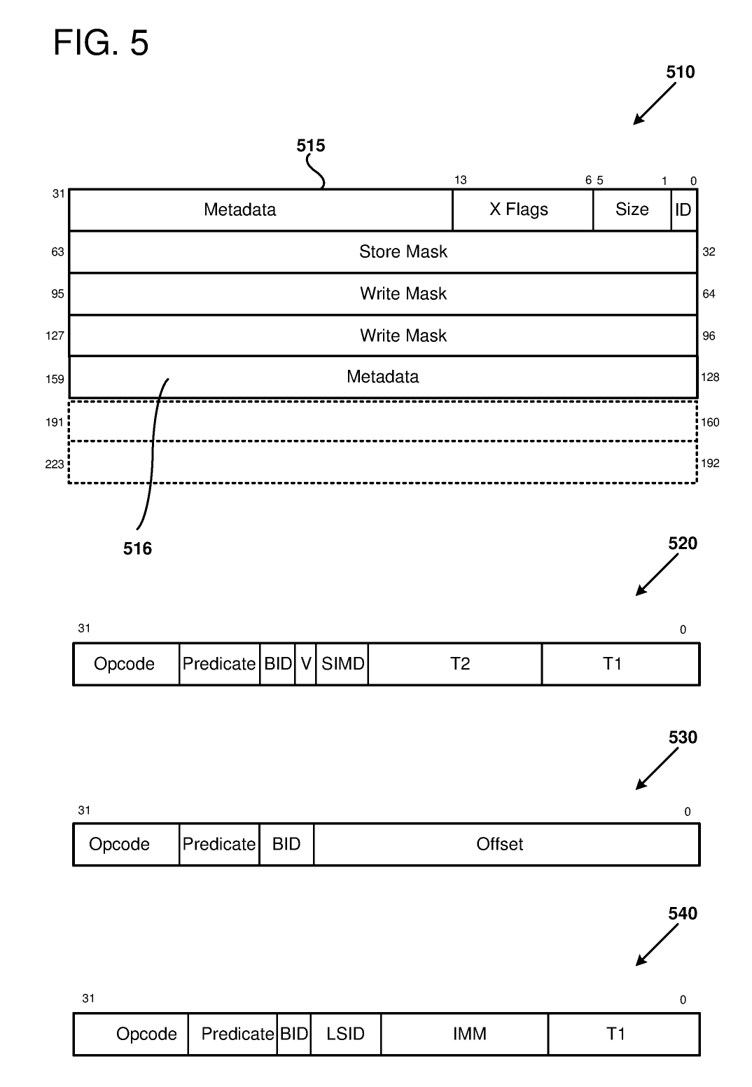

FIG. 5 is a diagram illustrating generalized examples of instruction formats for an instruction header 510, a generic instruction 520, a branch instruction 530, and a memory access instruction 540 (e.g., a memory load or memory store instruction). The instruction formats can be used for instruction blocks executed according to a number of execution flags specified in an instruction header that specify a mode of operation. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a number of execution flag fields, an instruction block size field, and an instruction header ID bit (the least significant bit of the instruction header). In some examples, the instruction header 510 includes additional metadata 515 and/or 516, which can be used to control additional aspects of instruction block execution and performance. In some examples, the additional metadata is used to indicate that one or more instructions are fused. In some examples, the additional meta data is generated and/or used by a hardware or software profiler tool.

The execution flag fields depicted in FIG. 5 occupy bits 6 through 13 of the instruction block header 510 and indicate one or more modes of operation for executing the instruction block. For example, the modes of operation can include core fusion operation, vector mode operation, branch predictor inhibition, memory dependence predictor inhibition, block synchronization, break after block, break before block, block fall through, and/or in-order or deterministic instruction execution. The block synchronization flag occupies bit 9 of the instruction block and inhibits speculative execution of the instruction block when set to logic 1.

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions.

The illustrated generic block instruction 520 is stored as one 32-bit word and includes an opcode field, a predicate field, a broadcast ID field (BID), a vector operation field (V), a single instruction multiple data (SIMD) field, a first target field (T1), and a second target field (T2). For instructions with more consumers than target fields, a compiler can build a fanout tree using move instructions, or it can assign high-fanout results to broadcasts. Broadcasts support sending an operand over a lightweight network to any number of consumer instructions in a core.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specify the instructions to which the results of the block-based instruction are sent. For example, an ADD instruction at instruction slot 5 can specify that its computed result will be sent to instructions at slots 3 and 10, including specification of the operand slot (e.g., left operation, right operand, or predicate operand). Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of groups of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The memory access instruction 540 format includes an opcode field, a predicate field, a broadcast ID field (BID), an immediate field (IMM), and a target field (T1). The opcode, broadcast, predicate fields are similar in format and function as described regarding the generic instruction. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. The immediate field can be used as an offset for the operand sent to the load or store instruction. The operand plus (shifted) immediate offset is used as a memory address for the load/store instruction (e.g., an address to read data from, or store data to, in memory).

### VIII. Example Processor Core State Diagram

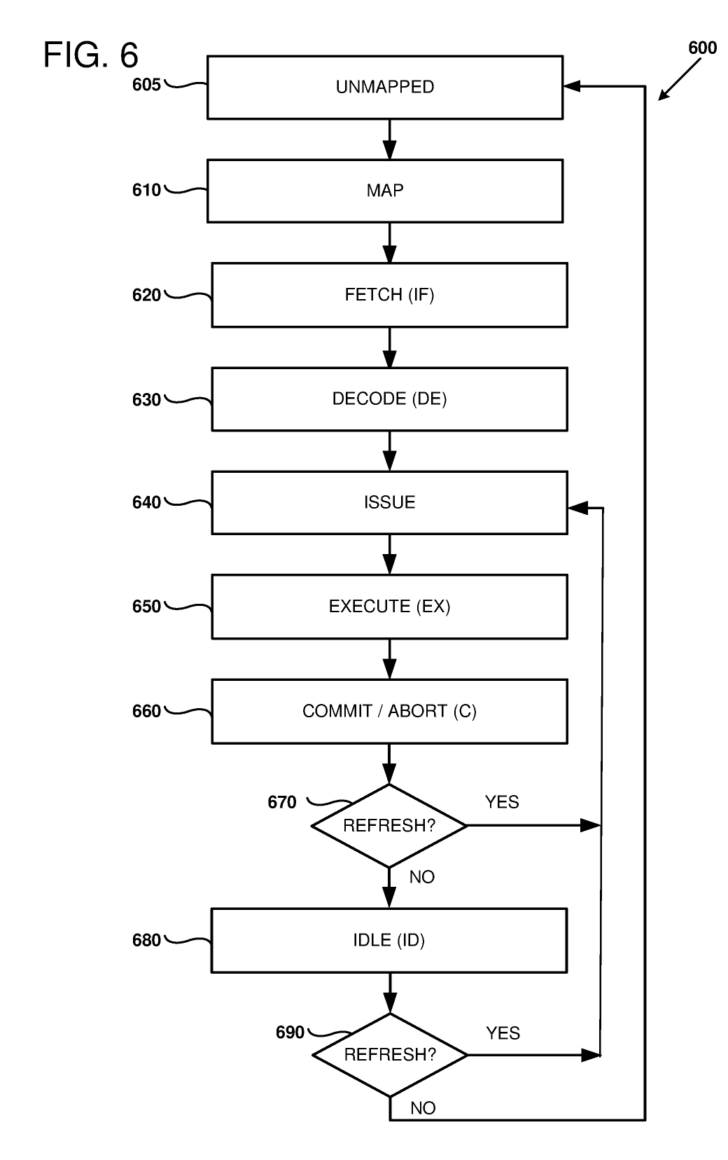

FIG. 6 is a state diagram 600 illustrating number of states assigned to an instruction block as it is mapped, executed, and retired. For example, one or more of the states can be assigned during execution of an instruction according to one or more execution flags. It should be readily understood that the states shown in FIG. 6 are for one example of the disclosed technology, but that in other examples an instruction block may have additional or fewer states, as well as having different states than those depicted in the state diagram 600. At state 605, an instruction block is unmapped. The instruction block may be resident in memory coupled to a block-based processor, stored on a computer-readable storage device such as a hard drive or a flash drive, and can be local to the processor or located at a remote server and accessible using a computer network. The unmapped instructions may also be at least partially resident in a cache memory coupled to the block-based processor.

At instruction block map state 610, control logic for the block-based processor, such as an instruction scheduler, can be used to monitor processing core resources of the block-based processor and map the instruction block to one or more of the processing cores.

The control unit can map one or more of the instruction block to processor cores and/or instruction windows of particular processor cores. In some examples, the control unit monitors processor cores that have previously executed a particular instruction block and can re-use decoded instructions for the instruction block still resident on the “warmed up” processor core. Once the one or more instruction blocks have been mapped to processor cores, the instruction block can proceed to the fetch state 620.

When the instruction block is in the fetch state 620 (e.g., instruction fetch), the mapped processor core fetches computer-readable block instructions from the block-based processors' memory system and loads them into a memory associated with a particular processor core. For example, fetched instructions for the instruction block can be fetched and stored in an instruction cache within the processor core. The instructions can be communicated to the processor core using core interconnect. Once at least one instruction of the instruction block has been fetched, the instruction block can enter the instruction decode state 630.

During the instruction decode state 630, various bits of the fetched instruction are decoded into signals that can be used by the processor core to control execution of the particular instruction, including generation of identifiers indicating relative ordering of memory access instructions. For example, the decoded instructions can be stored in one of the memory stores shown above, in FIG. 2. The decoding includes generating dependencies for the decoded instruction, operand information for the decoded instruction, and targets for the decoded instruction. Once at least one instruction of the instruction block has been decoded, the instruction block can proceed to issue state 640.

During the issue state 640, instruction dependencies are evaluated to determine if an instruction is ready for execution. For example, an instruction scheduler can monitor an instruction's source operands and predicate operand (for predicated instructions) must be available before an instruction is ready to issue. For some encodings, certain instructions also must issue according to a specified ordering. For example, memory load store operations are ordered according to an LSID value encoded in each instruction. In some examples, more than one instruction is ready to issue simultaneously, and the instruction scheduler selects one of the ready to issue instructions to issue. Instructions can be identified using their IID to facilitate evaluation of instruction dependencies. Once at least one instruction of the instruction block has issued, source operands for the issued instruction(s) can be fetched (or sustained on a bypass path), and the instruction block can proceed to execution state 650.

During the execution state 650, operations associated with the instruction are performed using, for example, functional units 260 as discussed above regarding FIG. 2. As discussed above, the functions performed can include arithmetical functions, logical functions, branch instructions, memory operations, and register operations. Control logic associated with the processor core monitors execution of the instruction block, and once it is determined that the instruction block can either be committed, or the instruction block is to be aborted, the instruction block state is set to commit/abort state 660. In some examples, the control logic uses a write mask and/or a store mask for an instruction block to determine whether execution has proceeded sufficiently to commit the instruction block.

At the commit/abort state 660, the processor core control unit determines that operations performed by the instruction block can be completed. For example memory load store operations, register read/writes, branch instructions, and other instructions will definitely be performed according to the control flow of the instruction block. For conditional memory instructions, data will be written to memory, and a status indicator value that indicates success generated during the commit/abort state 660.

In some examples of the disclosed technology, one or more types of exception events result in a “partial commit” In this case, the instruction block does not further execute after the event is processed. However, the state up to the point of the event is committed. For example, if an abort results from processing the exception event, some changes to the processor architectural state can be allowed to be committed even if the remainder of the instruction block is not committed.

Alternatively, if the instruction block is to be aborted, for example, because one or more of the dependencies of instructions are not satisfied, or the instruction was speculatively executed on a predicate for the instruction block that was not satisfied, the instruction block is aborted so that it will not affect the state of the sequence of instructions in memory or the register file. Regardless of whether the instruction block has committed or aborted, the instruction block goes to state 670 to determine whether the instruction block should be refreshed. If the instruction block is refreshed, the processor core re-executes the instruction block, typically using new data values, particularly the registers and memory updated by the just-committed execution of the block, and proceeds directly to the execution state 650. Thus, the time and energy spent in mapping, fetching, and decoding the instruction block can be avoided. Alternatively, if the instruction block is not to be refreshed, then the instruction block enters an idle state 680.

In the idle state 680, the processor core executing the instruction block can be idled by, for example, powering down hardware within the processor core, while maintaining at least a portion of the decoded instructions for the instruction block. At some point, the control unit determines 690 whether the idle instruction block on the processor core is to be refreshed or not. If the idle instruction block is to be refreshed, the instruction block can resume execution of instructions at issue state 640. Alternatively, if the instruction block is not to be refreshed, then the instruction block is unmapped and the processor core can be flushed and subsequently instruction blocks can be mapped to the flushed processor core.

While the state diagram 600 illustrates the states of an instruction block as executing on a single processor core for ease of explanation, it should be readily understood to one of ordinary skill in the relevant art that in certain examples, multiple processor cores can be used to execute multiple instances of a given instruction block, concurrently.

### IX. Example Exception Handling

Processing exception events in block-based processors presents a number of challenges. Processors implemented according to such architectures can be configured to handle exceptions and interrupts immediately, by reversing execution of some instructions in the instruction block, or by waiting until the end of an instruction block to handle the exception event. As used herein, exception events include software-generated exceptions and hardware interrupts. Examples of suitable software exceptions that can be processed according to the disclosed technology include, but are not limited to: page faults, divide by zero errors, floating point anomalies, overflow conditions, illegal branch instructions (e.g., to an illegal branch location or mis-aligned target address), illegal memory accesses, memory violation (e.g., a memory load from an illegal or mis-aligned address location), security violation (e.g., an attempted access to memory or other processor resources not allowed by a process' current privilege level), or reaching debug breakpoints. Examples of suitable hardware interrupts include, but are not limited to, interrupts generated by timers, I/O interface signals. They include synchronous and asynchronous signal inputs to a processor core as well as signals indicating changes in power states or device malfunctions.

For some of these exception events, the exception handler is configured such that the architectural state is visible to the programmer. For example, when setting and using breakpoints for a debugger, it is often desirable that all of the architectural state for a core be made visible to the programmer. For other examples, such as page fault exceptions or timer interrupts, the event handler typically will not provide access to all architectural state. As shown in Table 1 below, exception events can be classified to whether the system state is visible to the programmer and according to how a program's control flow is affected.

TABLE 1

| | | Programmer View | |
|---|---|---|---|
| | | Visible | Invisible |
| Program | Immediate | Example: Software | Example: Page fault |
| control flow | halt | breakpoint | |
| | Delayed | Example: Keyboard | Example: Timer |
| | halt | interrupt handled | interrupt handled |
| | | by the program | by the OS |
| | Resume | Example: Software | Example: Page fault |
| | | interrupts, debugging | |
| | Not | Example: Language- | Example: Illegal |
| | resumed | supported exceptions | memory access |

Exception events in the “visible” column provide access to current architectural state, including the state of individual instructions within an instruction block. Examples of different types of handling of program control flow are shown in the different rows. For example, the program control flow can be immediately halted, halted after a delay, and an instruction block execution can be resumed, or not resumed.

In some operating modes of block-based processors, it is desirable to define precise exception semantics such that there is a defined sequential ordering for the instructions within the block. In some examples, the instructions in the block are ordered according to an order in which a compiler determines that dependencies for the instructions will be satisfied. In some examples, the instructions can be made to appear to execute in their sequential order in memory, such as when provided a debugging view to a programmer Thus, it may be desirable for certain examples of disclosed exception handling to provide a view of architectural state reflective of sequential execution of an instruction block up to the instruction at which an exception event was detected or generated. In some examples, a programmer may desire to alter system state at a trigger or break point, for example, register and/or memory location values. In some examples, a context record can be created to identify the excepting instruction. The context record can be used to permit the operating system to resume execution of the instruction block after exception handling has been processed. In some examples, the context record can be stored on a stack. In some examples, it is desirable that instructions that have side effects such as memory load store instructions not cause additional memory operations when execution of an instruction block is resumed. For example, loading or storing to or from an I/O register can influence the value of subsequent loads or stores from the same, or even different, I/O registers. In atomic block architecture such as disclosed examples of block-based processors, instruction blocks commit, or do not commit, as a collection of side effects generated by the entire block. Thus, generating extraneous side effects can undesirably alter program state. However, in certain examples, a block may be partially committed with state that was generated up to an excepting instruction.

In some examples, a programmer may mark desired side effect instructions in a higher-level language program with a marker such as “volatile” and the compiler can flag such variables to the processor. The use of such instructions can present challenges for examples that include speculative execution.

In some examples, programmer invisible exceptions such as page faults can be handled at block boundaries. In such cases, context records for the instruction block can include only architectural state of the block, the address of the start of the block as a restart point, and an instruction identifier for the excepting instruction. However, restarting such instruction blocks can generate inconsistencies with side effects. In some examples, the compiler can address this by moving side effect instructions into a separate instruction block. Such instructions can be coupled with fence instructions to avoid excessive performance impact. However, such an approach can increase code size and otherwise affect code quality. In other examples, a processor core has hardware to support logging results of a first portion of an instruction block and replay the block when the instructions are re-executed. For example, all of the memory load instructions in instruction block can be logged.

In processors using a block-granularity exception model, a simulator is used to emulate execution of the block during certain debug or exception handling operations. A subroutine jump is made to invoke the simulator. Then, the calling block is simulated. State of the instruction block is stored in memory of processor address space, for example, a page in system memory. Thus, the exception can be handled at hardware until the start of the block and then switched to a software simulator or emulator for instruction-precise handling. In some examples, the simulator can run on the same core. Thus, the simulator can supply any state information that the user requests about the block, and will commit user updates to the state to the processor hardware.

In other examples, a debugging engine runs on another core with hardware access to the architectural state of the processor core that is being debugged.

Handling of interrupts is similar to handling of exceptions in many respects, except that in some examples of interrupts, the handling does not need to be as precise. For example, the processor can service the interrupt immediately, or service the interrupt at the end of the block, or retroactively handle the interrupt and restart the block. In some examples, hardware interrupts may be masked or unmasked, and synchronous or asynchronous. Hardware interrupts are typically generated by timers or I/O devices, and a processor may include an interrupt unit configure to receive interrupt signals.

During typical operation of a block-based program, intermediate results (such as values of the operand buffers) produced within an atomic instruction block are not available outside of a processor core where the instruction block is executed, at least until a block commits. However, the intermediate results can potentially be useful when a programmer is debugging a block-based program. In some examples of the disclosed technology, support is provided to potentially enable a programmer to debug a program targeted to the block-based processor. For example, support for debugging can be provided within compiler software, debug software, and/or the hardware of the block-based processor. The debugging tools are configured to have access to intermediate results generated during execution of an instruction block, before the block is committed. For example, operand values (left/right operand, predicate operands, or other suitable operands) can be transferred to a debugger via a suitable debugging interface.

### X. Example Block-Based Processor Core Exception Handling Microarchitecture

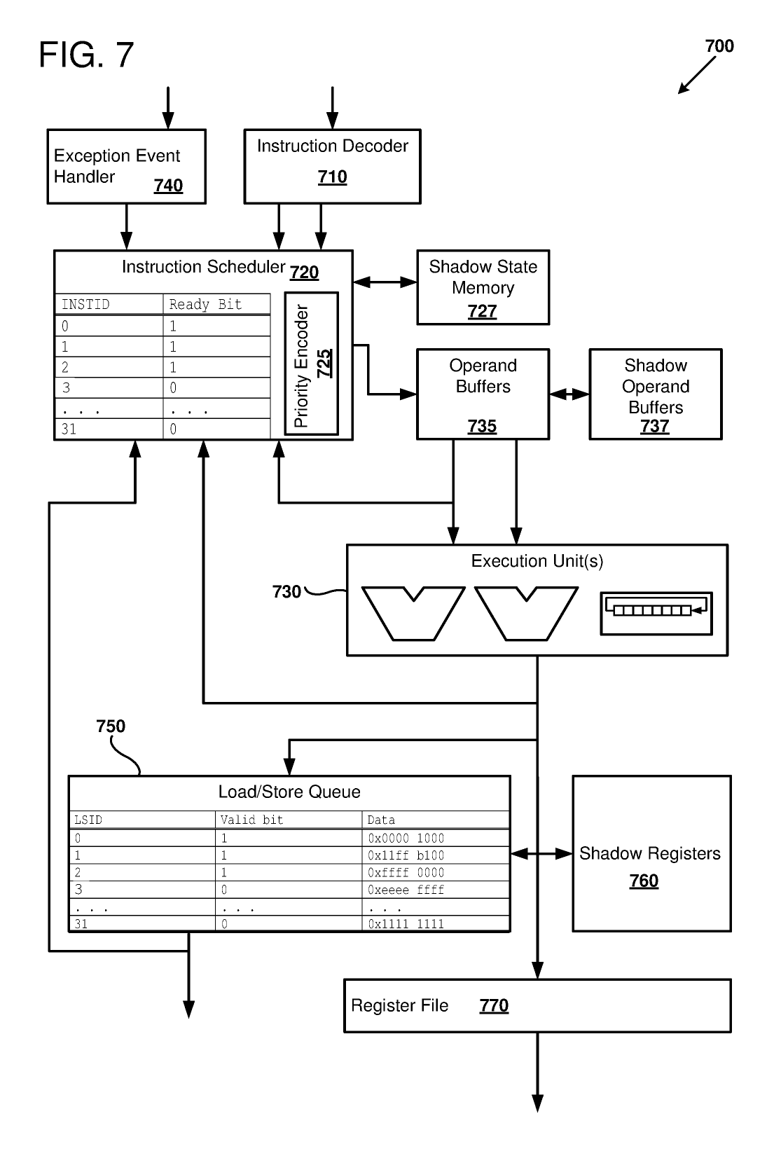

FIG. 7 is a block diagram 700 illustrating an example block-based processor core including features for facilitating exception handling as can be performed in certain examples of the disclosed technology.

For example, the microarchitecture depicted in FIG. 2 can be further enhanced with the structures depicted in FIG. 7 in order to provide improved exception handling in example block-based processors.

An instruction decoder 710 decodes instructions received from an instruction cache and provides them to an instruction scheduler 720 in order to determine instructions that are ready to issue and select one or more of the ready instructions to be executed. The instruction scheduler 720 tracks a number of different types of data for instructions in an instruction block. While most data tracked by the instruction scheduler is omitted from FIG. 7 for clarity, the instruction scheduler 720 shown stores a ready bit for each instruction in the instruction block, indexed by the instructions identifier (INSTID). When all dependencies for an instruction are satisfied, the instruction scheduler 720 sets the ready bit to indicate that the instruction can issue and execute. As discussed above, each instruction can have a variable number of dependencies, for example left operand, right operand, and/or predicate operands. In the illustrated examples, the instruction scheduler stores data for each instruction in a table in parallel. Ready bits and other scheduling information are provided to a priority encoder 725 which selects one or more instructions to issue. In some examples of the disclosed technology, all or a portion of such scheduling information can be logged by storing the data in a shadow state memory 727. The shadow state memory 727 stores copies of scheduler data that can be used to restore the block state after processing of an exception event has occurred. Suitable forms of memory for implementing the shadow state memory include but are not limited to registers, queues, and RAMs.

The operations for implementing the instruction can be performed by execution units 730. Operands that are generated for consumption by instructions are temporarily stored in a number of operand buffers 735. The operand buffers are monitored by the instruction scheduler 720, and when all of an instruction's dependencies are satisfied, is available for issue by the scheduler. In some examples of the disclosed technology, all or a portion of such operand values can be logged by storing the data in shadow operand buffers 737. The shadow operand buffers 737 store copies of operands that have been evaluated by the currently-executing instruction block. These stored values can be used to restore the block state after processing of an exception event has occurred. Suitable forms of memory for implementing the shadow operand buffers 737 include but are not limited to registers, queues, and RAMs.

The instruction scheduler 720 further receives exception event information from an exception event handler 740. Information provided by the exception event handler can include a signal indicating that an event has occurred, information for servicing the event, information about the type of the event (e.g., whether the event is a software exception or a hardware interrupt), or other attributes about the exception, for example whether the exception is masked, whether the exception was generated by a user process or a system process, whether the exception was received synchronously or asynchronously, a target location for transferring control flow of the processor to a second set of instructions, or other suitable exception information.

The example microarchitecture depicted also includes a load store queue 750, which stores data such as valid bits, which indicate whether a memory read instruction has executed successfully and thus loaded data into the load store queue, and the data itself, for example values read from memory using a memory load instruction. The example load store queue 750 is indexed by memory load store identifiers (LSID). In certain examples of the disclosed technology, memory access instructions can be encoded with an LSID field to indicate a relative ordering in which memory instructions must be executed according to the architecture. In other examples, dependencies or memory instruction ordering can be generated dynamically at run time. In some examples, the data stored for instructions in the load store queue can be used to later resume execution of the instruction block after returning from an exception handler. In other examples, data result operands generated by performing memory instructions can be stored in a number of shadow registers 760. Suitable forms of memory for implementing the shadow registers 760 include but are not limited to registers, queues, and RAMs.

When execution of an instruction block resumes after exception handling, the execution state of the instruction window can be restored by copying data from the shadow registers into appropriate registers in the data path. In the example of FIG. 7, the first three instructions having LSIDs of 0, 1, and 2 have executed as reflected by the valid bit being set in the load store queue 750. When execution of the instruction block is resumed, the control logic for the instruction window can use the valid bits to avoid re-executing certain instructions, for example memory load instructions. This can avoid side effects generated by re-executing an instruction that reads the same memory address twice. For example, memory mapped IO or other memory map structures may update the information that is read for subsequent instances of memory load instructions.

The example microarchitecture further includes a register file 770, which is used to store architectural register values, which can be passed to subsequent instruction blocks. Because the register values are typically all available when an instruction block is invoked, the values generated for register instructions are not typically logged for exception handling, as with memory and other instructions having side effects.

### XI. Example Transfer of Control and Resuming During Exception Handling

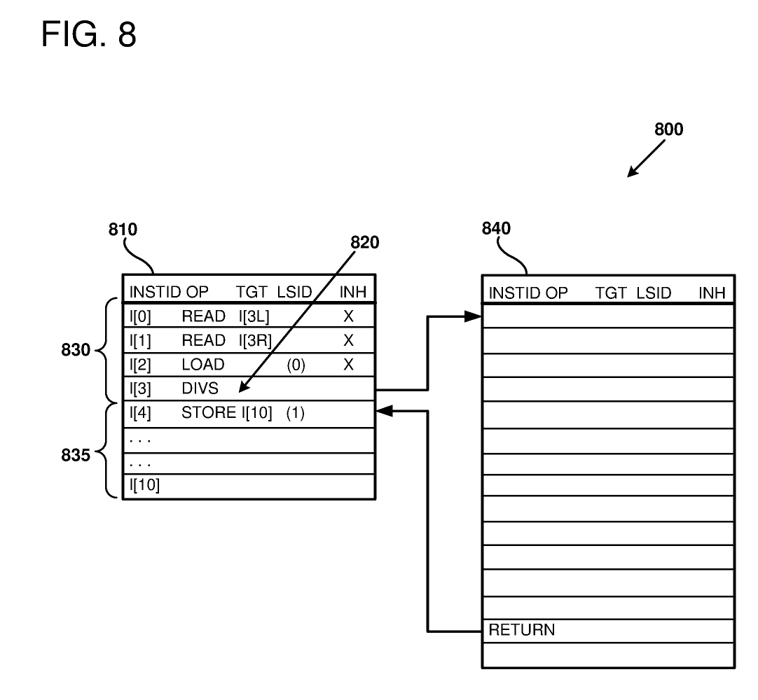

FIG. 8 is a diagram 800 depicting a high-level example of exception handling as can be performed in certain examples of the disclosed technology. As shown, as a first instruction block 810 is executing, an exception is generated by executing a signed divide (DIVS) instruction I[3] 820. For example, a floating point overflow or divide by zero can raise a software exception. After this first portion 830 has been executed the instruction windows exception handler catches this exception and proceeds to transfer control to a second instruction block 840. In some examples, data for the instruction block state that is to be saved can all be stored on receiving an exception. In other examples, data for restoring the block after an exception is stored on a rolling basis, for example as each instruction is executed by the processor core. The event handler can be implemented by one or more instruction blocks. After the exception handler has completed processing of the event, execution returns to a next portion 835 the first instruction block 810 in which the exception (or hardware interrupt) was raised. The instruction scheduler sets the inhibit bits of previously-executed instructions I[0], I[1], and I[2] so that the scheduler will not attempt to schedule the instructions in the first portion 830 again.

XII. Example Transfer of Control with Re-Execution During Exception Handling

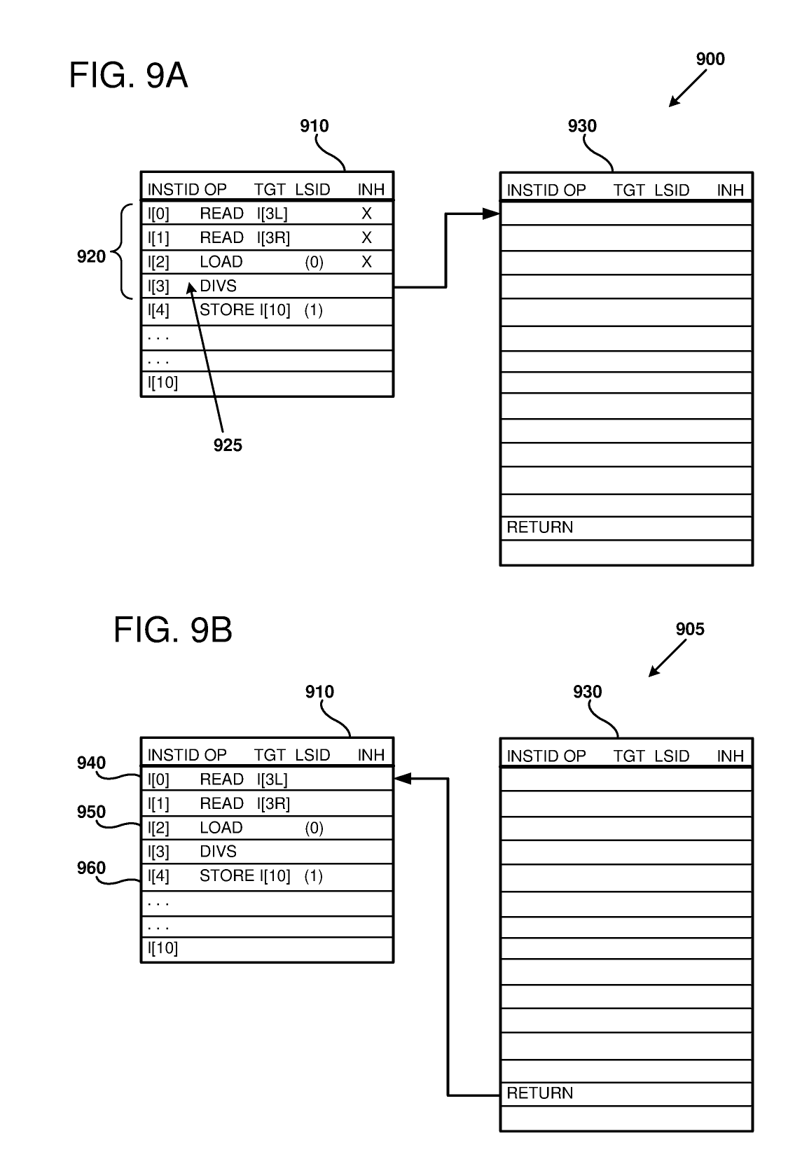

FIGS. 9A and 9B are diagrams 900 and 905, respectively, depicting a high-level example of exception handling as can be performed in certain examples of the disclosed technology. Similar to the case described above regarding FIG. 8, an exception is generated when in a first instruction block 910 as part of executing a first portion of instruction 920 executing instruction I[3] 925. The instruction windows exception handler caches its exception and proceeds to transfer control to a second instruction block 930. In some examples, data for the instruction block state is stored upon receiving the exception. In other examples, data for restoring the block after processing the exception is stored on an ongoing basis.

After the exception handler has completed processing of the event, execution resumes at the first instruction block 910 in which the exception (or hardware interrupt) was raised. However, in the illustrated example, execution resumes starting with the first available instruction in the instruction block, I[0] 940. As shown, the inhibit bit for each of the instructions in the first portion of the instruction block 910 have been reset by the instruction scheduler such that the instructions will re-execute upon receiving their dependencies. However, for certain instructions that have side effects, such as memory load instructions, or memory store instructions, some operations associated with the instruction will not be re-performed. For example, the load instruction 950 will execute upon receiving its dependencies, but will not reload a result from memory. This can avoid issues with, for example, memory mapped I/O. Similarly, a memory store instruction 960 will not actually write its result operand back to memory. This is because the memory may have already been written prior to processing the exception. This can also avoid issues with re-executing memory instructions in, for example, memory mapped I/O situations. As shown, memory instruction LSID values can be used to index a table in order to retrieve values that were previously loaded prior to processing the exception. For example, when the load instruction is re-executed, the LSID index zero is used to load the value from, for example, a load store queue, or a set of shadow registers storing the value.

XIII. Example Transfer of Control after Commit During Exception Handling

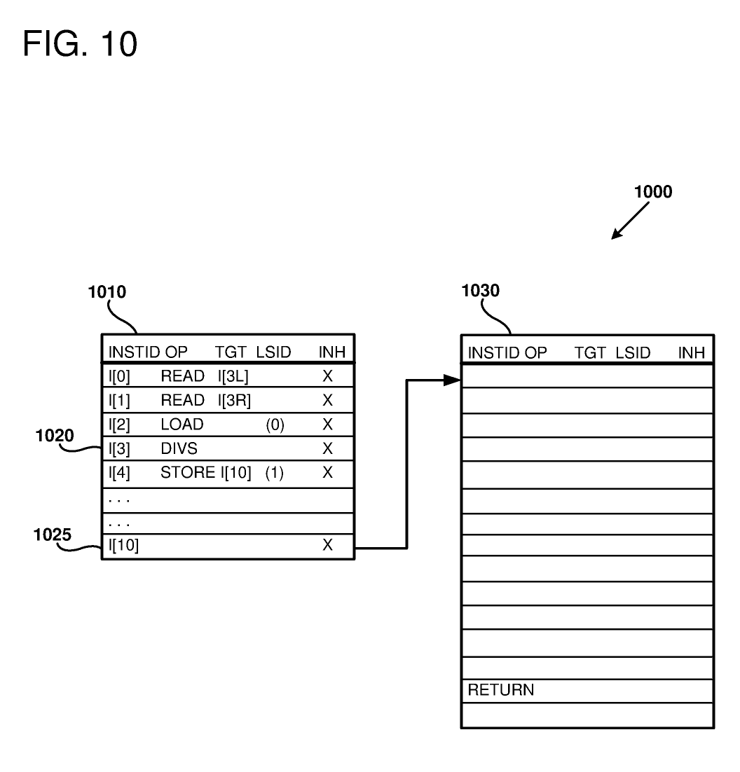

FIG. 10 is a diagram 1000 depicting a high-level example of exception handling as can be performed in certain examples of the disclosed technology. In the illustrated example, an exception is raised when the first instruction block 1010 executes instruction I[3] 1020. In contrast to the examples discussed above regarding FIG. 8 and FIGS. 9A and 9B, in this example processing of the exception is delayed until the first instruction block 1010 has completed execution and has committed. After the block 1010 is committed, and all instructions with satisfied dependencies (e.g., including instruction I[10] 1025) have executed, processor execution proceeds to a second instruction block 1030 in order to process the exception.

### XIV. Example Method of Processing Exceptions by Restoring Instruction Block State

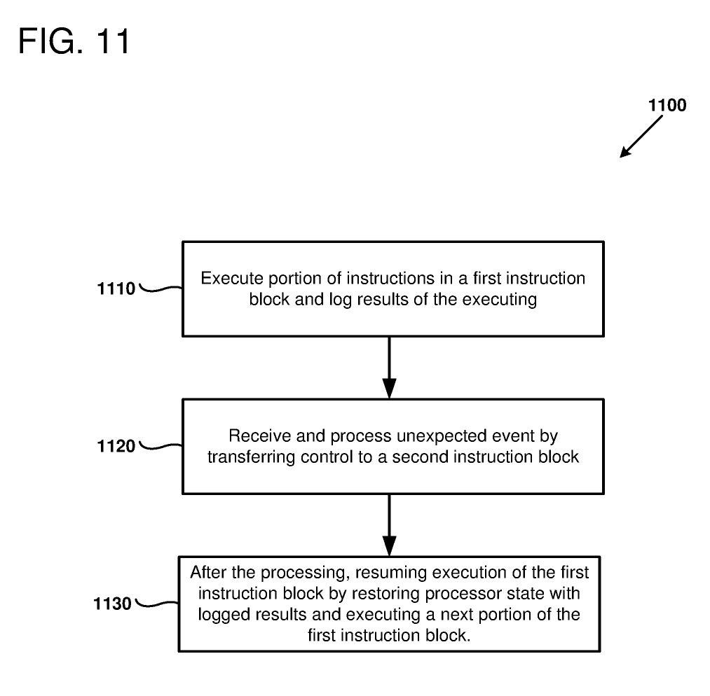

FIG. 11 is a flowchart 1100 outlining an example method of processing exception events in a block-based processor, as can be performed in certain examples of the disclosed technology. For example, block-based processor cores having architectures similar to those discussed above regarding FIGS. 1-7, can be used to implement the disclosed method.

At process block 1110, a portion of instructions of a first instruction block is executed and results are logged from this portion of the instructions. In some examples, the logged results can be performed on an ongoing basis, for example, as each instruction in the instruction block executes and retires. In other examples, logging of the results is delayed until an exception event is received. Thus, overhead associated with logging the results can be delayed until exception actually occurs, thereby saving resources and energy. In some examples, behavior of result logging can be configured according to settings defined by system or user processes executing on the host processor. Any data useful in restoring instruction block state after processing an exception can be stored. In some examples, the results logging includes storing result operand data that is generated by executing one or more memory instructions, such as memory load or memory store instructions within the executed portion of the instructions. In some examples, side effects other than loaded or stored memory values can also be logged along with the result operand generated by the memory instruction. For example, condition flags or other changes to the processor core state can be logged. In some examples, generated target operands to be consumed by instructions within the instruction block can be logged. In some example, data indicating whether particular instructions in the instruction block have executed can be logged. In some examples, dependency, ready, and issue state from, for example, an instruction scheduler, are logged.

At process block 1120, an exception event is received. For example, an exception event can be raised by software for example by debug or break points, operating system hooks, or error conditions such as divide by zero or overflow conditions. In some examples, the exception event is generated by a hardware interrupt such as by a timer or an I/O device. The unexpected event is processed but transferring control of the processor to a second instruction block. Depending on the configuration of the processor core, and the type and/or data in the exception event signal, the exception event handler may begin immediate execution, or in other examples, may wait until current first instruction block completes execution and commits

At process block 1130, after the exception event is processed, execution of the first instruction block is resumed by restoring processor state with logged result data generated at process block 1110 and executing a next portion of the first instruction block that does not include executed instructions for which results were logged. For example, processor state may be restored from data stored in a shadow register and/or in a load store queue prior to resuming execution. The processor core is placed in a state where it appears as if the core was before exception handling began. In some examples, the first instruction block and the second instruction block are executed by the same processor core, thus, all of the state of the first instruction block is restored when returning from the second instruction block. In some examples, the context of the processor core can be placed on a stack, and these values are then stacked and then popped and then used to restore at least a portion of the state of the processor core just prior to resuming execution of the first instruction block. In some examples, restoring the processor state includes re-executing at least one instruction of the previously executed portion of instructions by providing stored result operand data as at least one result operand of the re-executed instruction. For example, data produced by performing a memory load instruction can be provided as a result, and the memory load instruction then appears to have returned to its previous state, without re-accessing the memory, potentially causing side effects. In some examples, resuming execution of the first instruction block includes re-executing at least one instruction of the portion of instructions where at least one of the re-executed instruction receives an input operand from the logged results. In some examples, executing the next portion of the first instruction block is performed without re-executing the previously executed portion of instructions. For example, enough state information is logged to return the processor core to its state that it was in prior to processing the exception. In some examples, the second instruction block performs a portion of a debugger application that can be used to analyze state values within the processor core for the first instruction block.

Code listing 1, below, provides an example of an exception case written in C language code that could generate an exception processed according to the method outlined in FIG. 11. All of the code in the listing is compiled into a single instruction block of EDGE ISA instructions. As shown, if the variable y is zero, then dividing x by y will raise a divide-by-zero exception and transfer control of the processor to an exception handler. Thus, even though the instruction block has not completed execution and committed, the exception handler to which control is transferred expects the new values of x and y to be available for exception handling and debug operations.

Listing 1

```
z = x + y;
    if (z <= 5) {
        x += 1;
        y −= 1;
        x /= y;
    }
```

XV. Example Method of Processing Exceptions, Including Selecting which Instruction to Re-Execute

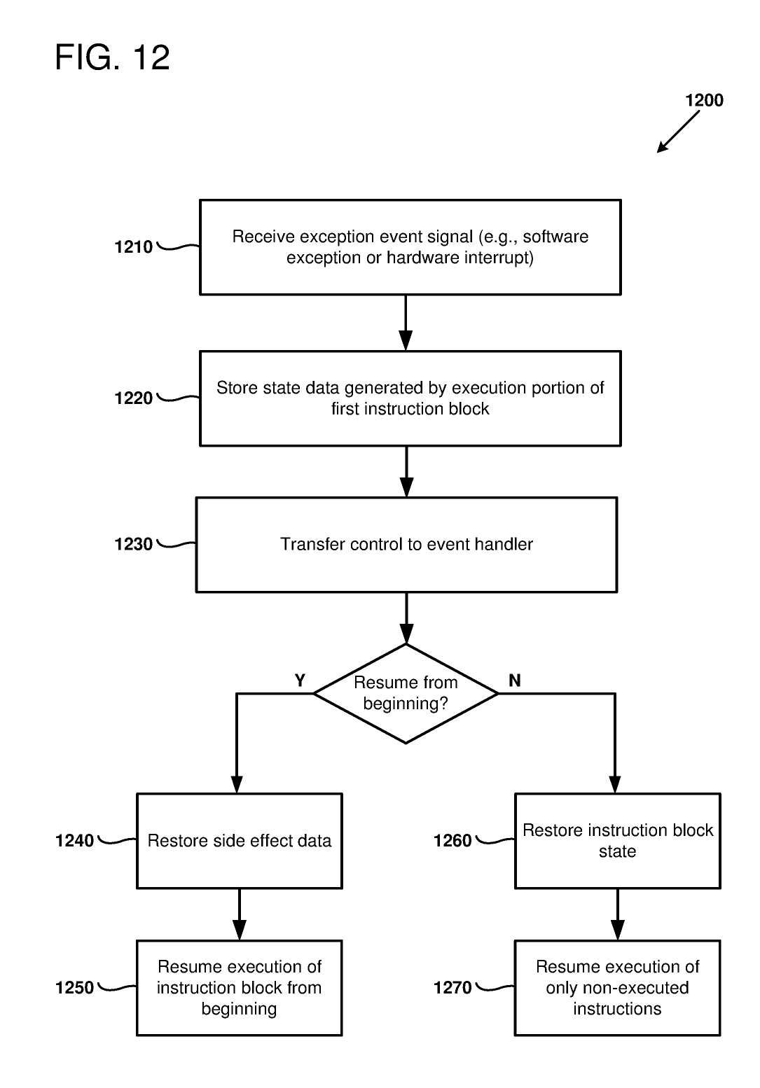

FIG. 12 is a flowchart 1200 outlining an example method of processing exception events, as can be performed in certain examples of the disclosed technology.

At process block 1210, an exception event signal such as a software exception or a hardware interrupt is received by a processor core.

At process block 1220, state data for the processor core is stored in, for example, the load store queue, shadow registers, a context stack, or other suitable storage. In some examples, all operand values in the instruction window, and their associated valid bits are saved and later refreshed. In other examples, memory load values that have been executed are stored with along with or indexed by, their LSIDs. Thus, if the entry associated with a particular LSID is valid or available, then the processor can use that, otherwise a memory load will be performed. Further, other state associated with instruction of the block, including memory instructions, can be buffered. For example, condition codes or other state generated by executing instructions, can be stored. In some examples, these stored values can be made available to a debugger for inspection while the first instruction block is interrupted.

At process block 1230, control of the processor is transferred to an event handler. For example, the event handler can include a debugger or can be functions provided by the operating system, or other supervisory processes. Any suitable operations for handling the event can be performed, for example, a processor thread may be killed, execution may be allowed to continue, processor thread may be aborted, an interrupt handler may be called, or other suitable operations are performed. The event handler or processor core itself can then determine whether execution of the first instruction block should be resumed from the beginning, or whether execution should proceed from an intermediate state within the block. In other examples, execution of the first instruction block may be aborted completely. In other examples, execution of the first instruction block is not resumed, but results generated up to the exception point are committed.

If execution is to resume from the beginning of the first instruction block, the method proceeds to process block 1240, in order to restore side effect data, and other stored state data that was generated at process block 1220. After sufficient side effect data has been restored, the method proceeds to process block 1250.

At process block 1250, execution of the instruction block resumes from the beginning. It should be noted that many instructions in the instruction block would not typically be affected by side effects or memory load store operations at all. For example, instructions that are dependent on register file values, immediate values, or intermediate result operands generated by such instructions, can simply be re-executed to place the instruction of the processor back in the state it was when the instruction block was interrupted.

If it is determined that execution of the first instruction block should not resume from the beginning, such as may be determined based on the type of exception or interrupt, the method proceeds to process block 1260. At process block 1260, instruction block state is restored. For example, additional data may have been logged that can be used to restore the instruction block state, without re-executing previously executed instructions. After the instruction block state has been restored, the method proceeds to process block 1270. At process block 1270, execution of the first instruction block is resumed by allowing non-executed instructions to issue and execute.

### XVI. Example Method of Handling Events

FIG. 13 is a block diagram 1300 outlining an example method of handling events detected in a processor. For example, block-based processors having architectures such as described above regarding FIGS. 1-7 can be used to perform the method of FIG. 13.

At process block 1310, an exception event signal is received, such as a software exception or a hardware interrupt.

At process block 1320, state data is stored or logged so that execution of the first instruction block can resume after the event handler has completed handling the event.

At process block 1320, responsive to detecting an event, control of the processor is transferred to a second instruction block prior to completing execution of the first instruction block.

At process block 1330, a third portion of instructions are executed.

In some examples, the first, second, and third instruction blocks are instructions implemented using a try/catch/throw block. Such language constructs are provided by languages such as C++ and Java and by operating systems, such as Microsoft Windows and Linux operating systems. In some examples, the first instruction block includes instructions to implement a try instruction of a try/catch block. If the try instruction raises an exception, then an event is generated, and control of the processor is transferred to a second instruction block. The second instruction block can include instructions that are specified by a cache instruction that is defined by the try/catch block. In some examples, the try/catch block construct can further include a throw instruction that is defined by the try/catch block. Thus, rather than resuming execution of the first instruction block, control of the processor will proceed to the throw instruction. In some examples, the cache portion of the try/catch block specifies the condition under which the throw instruction will be executed. In other examples, the third portion of instructions are in the first instruction block, and the third portion of instructions are executed without re-executing the first portion of instructions. In other examples, the third portion of instructions are in the first instruction block and the third portion of instructions are executed subsequently to re-executing the first portion of instructions. At least one instruction of the first portion of the instructions is executed using a stored result operand generated at process block 1310.

Code listing 2, below, illustrates C++ style exception handling in which software is used to detect error conditions and throws exceptions. In this particular example, the first instruction block executes. When the value of y is zero, an exception is raised and handled by transferring control to a second instruction block when the throw statement is reached. The second instruction block in turn locates the catch block, previously registered for handling exceptions for this particular try block, and then jumps to a third instruction block implementing the beginning of the catch block. The try block terminates after the exception is handled.

Listing 2

```
try {
    z = x + y;
    if (z <= 5) {
        x += 1;
        y −= 1;
        if (y == 0) {
            throw 0;
        }
        x /= y;
    }
}
catch (int e) {
    . . .
}
```

Code listing 3, below, illustrates an example of Microsoft Windows-style exception handling in which there is not explicit throw statement defined. Similar to listings 1 and 2 above, the x /=y statement will cause an exception when y is zero. Control will then be transferred to the _except block to handle the exception. In this particular example, after the exception is handled program control flow may or may not return back to the excepting try block. For example, the filter function can include code that changes the value of y so that execution can proceed within the _try block.

Listing 3

```
_try {
    z = x+y;
    if (z<=5) {
        x += 1;
        y −= 1;
        x /= y;
    }
}
_except( filter( GetExceptionCode( ),
    GetExceptionInformation( )) ) {
    . . .
}
```

### XVII. Example Computing Environment

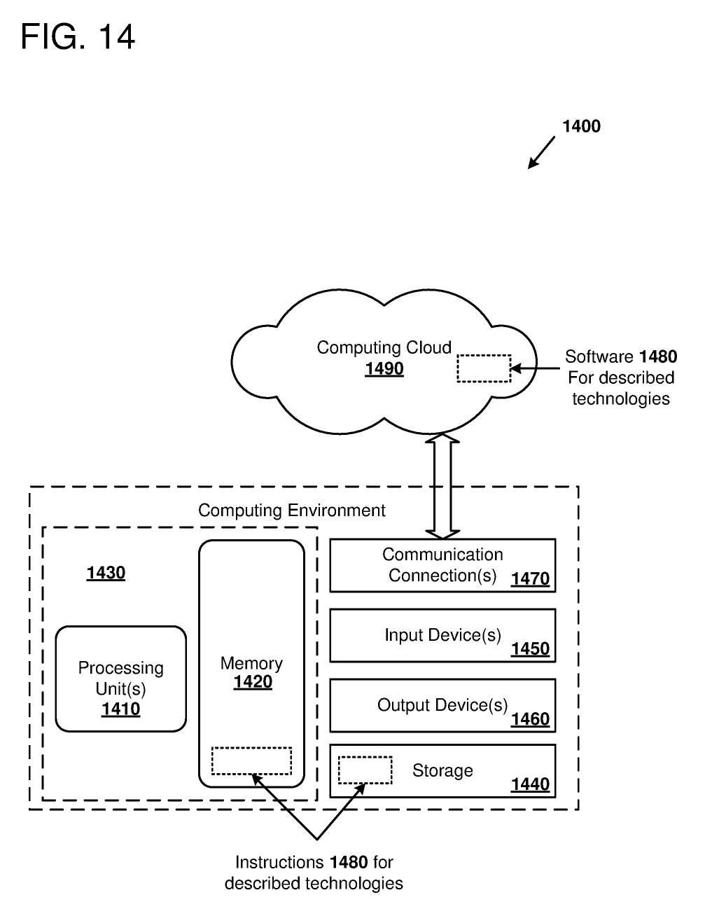

FIG. 14 illustrates a generalized example of a suitable computing environment 1400 in which described embodiments, techniques, and technologies, including processing events such as software exceptions and hardware interrupts, while executing an instruction block targeted for a block-based processor, can be implemented.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input devices 1450, one or more output devices 1460, and one or more communication connections 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment 1430, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

One or more computer-readable storage media may store computer-readable instructions that when executed cause a computer to perform the method for compiling instructions targeted for execution by a block-based processor. A block-based processor may be configured to execute computer-readable instructions generated by the method.

### XVIII. Additional Examples of the Disclosed Technology

Additional examples of the disclosed subject matter are discussed herein in accordance with the examples discussed above.

In some examples of the disclosed technology, a system of one or more computers can be configured to perform particular operations or actions by executing computer instructions stored as software, firmware, hardware, or a combination thereof that causes the system to perform the disclosed actions. According to one example of the disclosed technology, a method of handling unexpected events in a block-based processor includes executing a portion of instructions of a first instruction block and logging results of the executing the portion of the instructions, receiving an exception event and processing the unexpected event by transferring control of the processor to a second instruction block, and after the processing the exception event, resuming execution of the first instruction block by: restoring processor state with the logged results, and executing a next portion of the first instruction block that does not include executed instructions for which results were logged. In some examples of the method, the exception event is generated by one of the following: executing a processor instruction, performing a memory access operation, or receiving an interrupt signal. In some examples, the logging includes storing result operand data generated by executing one or more memory load and/or memory store instructions of the executed portion of instructions. In some examples, the logged data can include a copy of processor core data, including instruction scheduler data stored in a shadow state memory, operand data stored in shadow operand buffers, and/or load/store queue data stored in shadow registers. The restoring processor state can include loading operand data from the stored result operand data for the memory load and/or memory store instructions. In some examples, the restoring processor state includes loading operand data from the stored result operand data for the memory load and/or store instructions.

In some implementations of the method, the logging includes storing result operand data for one or more memory load and/or memory store instructions of the executed portion of instructions and the restoring processor state includes re-executing at least one instruction of the portion of instructions by providing stored result operand data as at least one result operand of the re-executed instruction. In some examples, resuming execution of the first instruction block further includes re-executing at least one instruction of the portion of instructions, at least one of the re-executed instructions receiving an input operand from the logged results. In some examples, executing the next portion of the first instruction block is performed without re-executing the portion of instructions of the instruction block.

In some examples logged results include at least one of the following data: data produced by a memory load operation, data produced by a memory store operation, condition codes produced by executing the portion of instructions, or data indicating validity of a result operand. In some examples, the second instruction block (to which control is transferred) forms a portion of a debugger application. In some examples, the second instruction block forms a portion of an operating system event handler. In some examples, the transferring control includes changing the privilege level of the processor to execute the second instruction block.

In some examples, the logging includes logging of side effects caused by executing the portion of instructions of the first instruction block. In some examples, the side effects include condition flags, or other changes to the processor core state. The side effects may be visible or not visible to the programmer.

In some examples of the disclosed technology, an apparatus includes a block-based processor, including an exception event handler, a memory interface, and a block-based processor core coupled to the memory interface. The core is configured to, responsive to receiving an exception event signal from the exception event handler while executing a first instruction block, handle the exception event. The exception event handling includes storing state data for the processor core generated by the executing the first instruction block, transferring control of the processor core to a second instruction block, and resuming execution of the first instruction block by restoring the processor core with the stored state data.

In some implementations of the apparatus, a portion of the stored state data includes a result operand generated by a memory load instruction and being stored in a load store queue coupled to the processor core. In some examples, a portion of the stored state data includes a result operand stored in a random-access memory, the stored state data being indexed by a load store identifier (LSID) for the memory instruction that generated the stored state data. In some examples, the LSID is dynamically generated. In other examples, the LSID is encoded in the memory instruction or elsewhere in the memory instruction's instruction block. In some implementations, a portion of the stored state data is stored in a buffer, including: a result operand generated by executing a memory instruction, a load store identifier (LSID) encoded in the memory instruction, and a valid bit indicating that the result operand is valid for the first instruction block.

In some examples, an exception event handler generates the exception event signal based on one of the following: a software-generated exception comprising any one of the following: a page fault, a divide by zero, an overflow condition, a floating point anomaly, a branch instruction specifying an illegal branch location, an illegal branch instruction as signaled by a translation lookaside buffer (TLB) of the memory interface, a signal generated by a TLB miss detected by the memory interface, a memory read violation detected by the memory interface, a memory write violation detected by the memory interface, a security violation, a breakpoint, or a memory protection violation.

In some examples, a hardware interrupt generated by any one of the following: a timer, an input/output interface, a synchronous signal input to the processor core, an asynchronous signal input to the processor core, a signal indicating a change in power state, a signal indicating a device malfunction.

In some examples of the disclosed technology, a method of operating a processor includes: executing a first portion of instructions of a first instruction block and storing at least one result operand generated by executing a first portion of instructions in an instruction block, responsive to detecting an event, transferring control of the processor to a second instruction block prior to completing execution of the first instruction block, and executing a third portion of instructions. In some implementations, the first instruction block includes instructions implementing a try instruction of a try/catch block and the second instruction block includes instructions specified by a catch instruction defined by the try/catch block. In some examples, control of the processor or core is transferred to a software exception handler, an interrupt handler, or a debugger.

In some examples, the third portion of instructions are in the first instruction block and are executed without re-executing the first portion of instructions. In some examples, the third portion of instructions is in the first instruction block and is executed subsequently to re-executing the first portion of instructions. In some examples, previously stored instruction scheduler, result operand, and/or load/store queue data is used in re-executing at least one instruction of the first portion of instructions. In some examples, concurrently with executing the first portion of instructions of the first instruction block, the method includes speculatively executing a portion of instructions of a third instruction block and logging results of the speculatively executed portion of the instructions. The event is detected during speculative execution of the third instruction block.

In some examples, the transferring control is deferred until the third instruction block becomes the current instruction block and is performed by discarding results generated by the speculatively executing the third instruction block and performing the processing the exception event.

In some examples of the disclosed technology, a method of handling unexpected events in a block-based processor includes executing a first portion of instructions of a first instruction block and concurrently, speculatively executing a second portion of instructions of a second instruction block and logging results of the executing the second portion of the instructions. An exception event is received when the second instruction block is speculatively executed processed by transferring control of the processor to a third instruction block. In some examples, processing the exception event is deferred until the second instruction block becomes the current instruction block. In some examples, the exception event is processed by discarding results generated by the speculatively executing the instruction block and performing the processing the exception event.

One or more computer-readable storage media (such as storage devices and/or memory) can store computer-readable instructions that when executed by a computer cause the computer to perform any of the methods of handling exceptions, including software exceptions and hardware interrupts, disclosed herein. A block-based processor can be configured to execute computer-readable instructions generated by the method.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims and their equivalents.

We claim:

1. A method of handling unexpected events in a block-based processor, the method comprising:
executing a portion of instructions of a first instruction block and logging results of the executing the portion of the instructions;
receiving an exception event and processing the unexpected event by transferring control of the processor to a second instruction block; and
after the processing the exception event, resuming execution of the first instruction block by:
restoring processor state with the logged results, and
executing a next portion of the first instruction block that does not include executed instructions for which results were logged.

2. The method of claim 1, wherein the exception event is generated by one of the following: executing a processor instruction, performing a memory access operation, or receiving an interrupt signal.

3. The method of claim 1, wherein:
the logging comprises storing result operand data generated by executing one or more memory load and/or store instructions of the executed portion of instructions; and
the restoring processor state comprises loading operand data from the stored result operand data for the memory load and/or memory store instructions.

4. The method of claim 1, wherein:
the logging comprises storing result operand data for one or more memory load and/or memory store instructions of the executed portion of instructions; and
the restoring processor state comprises re-executing at least one instruction of the portion of instructions by providing stored result operand data as at least one result operand of the re-executed instruction.

5. The method of claim 1, wherein the resuming execution of the first instruction block further comprises:
re-executing at least one instruction of the portion of instructions, at least one of the re-executed instructions receiving an input operand from the logged results.

6. The method of claim 1, wherein the executing the next portion of the first instruction block is performed without re-executing the portion of instructions of the instruction block.

7. The method of claim 1, wherein the logged results comprise at least one of the following data: data produced by a memory load operation, data produced by a memory store operation, condition codes produced by executing the portion of instructions, or data indicating validity of a result operand.

8. The method of claim 1, wherein the second instruction block forms a portion of a debugger application.

9. The method of claim 1, wherein the logged results comprise side effects caused by executing the portion of instructions of the first instruction block.

10. An apparatus comprising a block-based processor, the apparatus comprising:
an exception event handler;
a memory interface; and
a block-based processor core coupled to the memory interface, the core being configured to, responsive to receiving an exception event signal from the exception event handler while executing a first instruction block:
store state data for the processor core generated by the executing the first instruction block,
transfer control of the processor core to a second instruction block, and
resume execution of the first instruction block by restoring the processor core with the stored state data.

11. The apparatus of claim 10, wherein:
a portion of the stored state data comprises a result operand generated by a memory load instruction, the portion being stored in a load store queue coupled to the processor core.

12. The apparatus of claim 10, wherein:
a portion of the stored state data comprises a result operand stored in a random-access memory, the stored state data being indexed by a load store identifier (LSID) encoded in a memory instruction that generated the stored state data.

13. The apparatus of claim 10, wherein:
a portion of the stored state data is stored in a buffer, the stored state data including: a result operand generated by executing a memory instruction, a load store identifier (LSID) encoded in the memory instruction, and a valid bit indicating that the result operand is valid for the first instruction block.

14. The apparatus of claim 10, wherein:
the exception event handler generates the exception event signal based on one of the following:
a software-generated exception comprising any one of the following: a page fault, a divide by zero, an overflow condition, a floating point anomaly, a branch instruction specifying an illegal branch location, an illegal branch instruction as signaled by a translation lookaside buffer (TLB) of the memory interface, a signal generated by a TLB miss detected by the memory interface, a memory read violation detected by the memory interface, a memory write violation detected by the memory interface, a security violation, a breakpoint, or a memory protection violation; and
a hardware interrupt generated by any one of the following: a timer, an input/output interface, a synchronous signal input to the processor core, an asynchronous signal input to the processor core, a signal indicating a change in power state, a signal indicating a device malfunction.

15. A method of operating a processor, comprising:
executing a first portion of instructions of a first instruction block and storing at least one result operand generated by executing a first portion of instructions in an instruction block;
responsive to detecting an event, transferring control of the processor to a second instruction block prior to completing execution of the first instruction block; and
executing a third portion of instructions.

16. The method of claim 15, wherein:
the first instruction block includes instructions implementing a try instruction of a try/catch block; and
the second instruction block includes instructions specified by a catch instruction defined by the try/catch block.

17. The method of claim 15, wherein the third portion of instructions are in the first instruction block, and wherein the third portion of instructions are executed without re-executing the first portion of instructions.

18. The method of claim 15, wherein:
the third portion of instructions are in the first instruction block; and
the third portion of instructions are executed subsequently to re-executing the first portion of instructions, at least one instruction of the first portion of instructions being executed using a stored result operand.

19. The method of claim 15, further comprising:
concurrently with the executing the first portion of instructions of the first instruction block, speculatively executing a portion of instructions of a third instruction block and logging results of the speculatively executed portion of the instructions; and
wherein the event is detected during speculative execution of the third instruction block.

20. The method of claim 19, wherein:
the transferring control is deferred until the third instruction block becomes the current instruction block; and
the transferring control is performed by discarding results generated by the speculatively executing the third instruction block and performing the processing the exception event.
